(19) United States
(12) Patent Application Publication
(10) Pub. No.: US 2008/0123720 A1
(43) Pub. Date: May 29, 2008

(54) DIGITAL DEMODULATION IC

(75) Inventor: Hideyuki Fujii, Ota-shi (JP)

Correspondence Address: OSHA LIANG L.L.P., 1221 MCKINNEY STREET, SUITE 2800, HOUSTON, TX, 77010, US

(73) Assignees: SANYO ELECTRIC CO., LTD., Osaka (JP); SANYO SEMICONDUCTOR CO., LTD., Gunma (JP)

(21) Appl. No.: 11/945,056

(22) Filed: Nov. 26, 2007

(30) Foreign Application Priority Data
Nov. 29, 2006 (JP) 2006-321185

(51) Int. Cl. H04L 25/00; H04L 27/00

(52) U.S. Cl. 375/216

(57) ABSTRACT

An I2C control unit stores set data in a register, the set data concerning operation of a gate circuit and a clock generator, according to address data from an external CPU. For analog TV broadcasting, the gate circuit is opened to thereby suspend operation of the clock generator. The set data from an external CPU is then supplied to the tuner.

### CROSS-REFERENCE TO RELATED APPLICATION

This application claims priority to Japanese Patent Application No. 2006-321185, filed on Nov. 29, 2006.

### BACKGROUND OF THE INVENTION

1. Field of the Invention

The present invention relates to a digital demodulation IC for use in a TV broadcasting receiving system having a digital circuit and an analog circuit.

2. Description of the Related Art

TV broadcasting includes digital TV broadcasting besides analog TV broadcasting, and many TV tuners are adapted to both types. In a TV tuner adapted to digital and analog TV broadcasting, the system control CPU provides a tuner control signal via a digital demodulation IC to a tuner, which is connected to the digital demodulation IC generally by means of an I2C bus.

Arrangements in which a tuner control signal is supplied via the digital demodulation IC is employed here because an arrangement in which a tuner control I²C(I2C) bus is connected to other device may create noise due to a clock or data transmitted to the tuner even when controlling other devices, adversely affecting the tuner performance. An arrangement in which a tuner control signal is supplied via a digital demodulation IC enables a digital demodulation IC to control access to the tuner, preventing unnecessary clock signals or data from being transmitted to the tuner. That is, the digital demodulation IC passes a tuner control signal for setting a channel, or the like, through to the tuner, and, in other cases for control, blocks the I2C bus to the tuner from operating.

It should be noted that a TV tuner adapted to digital and analog TV broadcasting is disclosed in Japanese Patent Laid-open Publication No. 2003-244570 or the like.

Here, although the digital demodulation circuit need not operate in order to receive analog TV broadcasts, in actual practice, the digital demodulation circuit must. operate in order for the I2C circuit to operate as required for control of the tuner. In the above, the digital demodulation circuit, which has a clock generator, operates according to a system clock from the clock generator, and thus the clock generator also operates. The clock generator, however, results in a noise source when receiving analog TV broadcasting, and deteriorates the analog TV broadcasting receiving capacity.

### SUMMARY OF THE INVENTION

According to the present invention, even when a system clock stops and the digital demodulation circuit stops operating, data exchange between the tuner and the CPU is still possible.

### BRIEF DESCRIPTION OF THE DRAWINGS

FIG. 1 is a diagram showing the overall structure of a system according to the present invention;

FIG. 2 is a diagram showing a structure of a digital demodulation IC; and

FIG. 3 is a diagram showing sequential states of operation of the digital demodulation IC.

### DESCRIPTION OF THE PREFERRED EMBODIMENT

In the following, an embodiment of the present invention will be described based on the accompanying drawings.

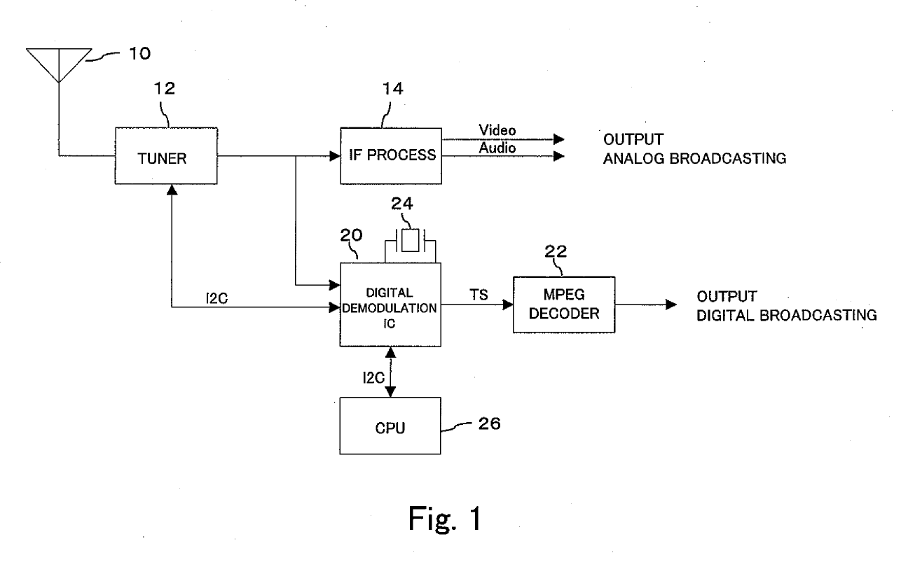

FIG. 1 shows a complete structure of a digital and analog TV broadcasting receiving system. An antenna 10 is connected and supplies the received wave to a tuner 12. The tuner 12 carries out a reception process, including down-conversion, relative to the received wave or the like to supply an analog intermediate frequency signal to an IF process circuit 14. The IF process circuit 14 demodulates a video IF signal (VIF) and a sound IF signal (SIF) to produce and output a video signal (Video) and an audio signal (Audio). Display is achieved using the video signal, and sound output from the speaker is achieved using the audio signal.

The intermediate frequency signal from the tuner 12 is supplied also to a digital demodulation IC (integrated circuit) 20. The digital demodulation IC 20 carries out a digital demodulation process relative to a digitally modulated signal in the intermediate frequency signal to obtain an MPEG-TS (transport stream) signal. An MPEG-TS signal is supplied to an MPEG decoder 22 to be decoded, whereby a digital broadcasting signal is obtained.

A clock generator 24 is connected to the digital demodulation IC 20, so that the digital demodulation IC 20 can operate according to a system clock supplied from the clock generator 24.

The digital demodulation IC 20 is connected to a CPU 26 via an I2C bus, or a serial bus, so that the operation of the digital demodulation IC 20 is controlled through a signal from the CPU 26. The digital demodulation IC 20 is also connected to the tuner 12 via the I2C bus, so that the digital demodulation IC 20 supplies a tuner control signal from the CPU 26 to the tuner 12.

In this embodiment, in the digital/analog TV broadcasting receiving system, such as is shown in FIG. 1, the CPU is still able to control the tuner, even if the clock generator for the digital demodulation IC stops operating.

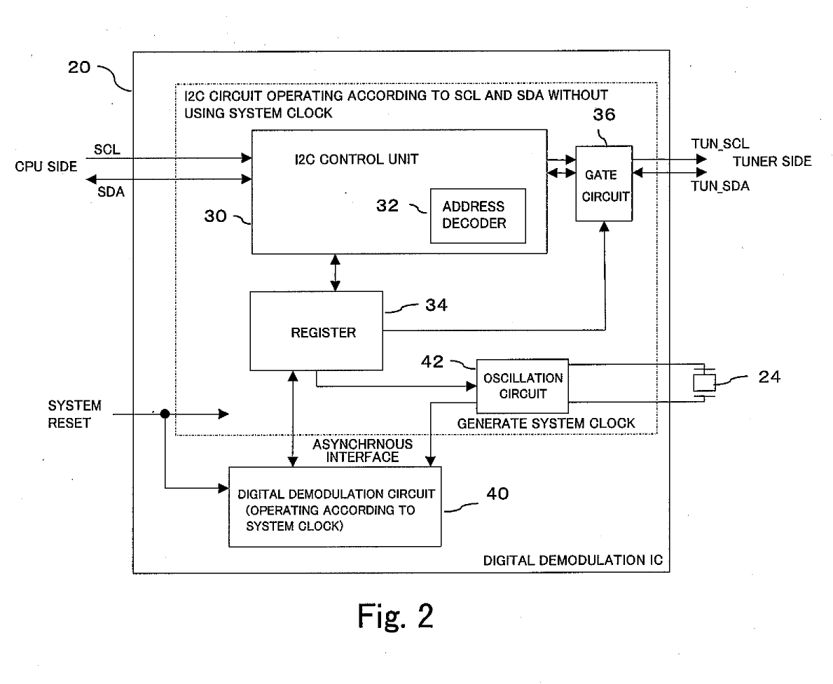

FIG. 2 shows one example of a circuit structure of the digital demodulation IC 20 according to the present embodiment. An I2C control unit 30 is connected to the CPU 26 via the I2C bus. The I2C bus is formed using two serial buses for respectively transmitting a clock SCL and data SDA, in which a clock SCL is transmitted unidirectionally from the CPU 26, i.e. a clock SCL is only transmitted from the CPU 26 to the I2C control unit 30. Data SDA is transmitted bidirectionally.

The I2C control unit 30 recognizes a break point of the data SDA, or a serial data, based on a clock SCL, and processes the data SDA. For example, the I2C control unit 30 may send and receive the value of data SDA at a timing corresponding to falling of a clock SCL. For example, during data transmission, data SDA is changed with a clock SCL in an H level and SDA is changed with the clock SCL in an L level in order to transmit start and stop of data transmission. It should be noted that the above protocol can be desirably defined according to the published standard for the I2C.

Here, the I2C control unit 30 incorporates an address decoder 32, while the data SDA contains address data. Thus, the address decoder 32 decodes the data SDA sent from the CPU 26 to restore address data contained therein.

The I2C control unit 30A is connected to a register 34. The register 34 includes a plurality of registers. When the address data in the data SDA indicates the slave address of the digital demodulation IC 20, the data sent following the address data is written into the corresponding address in the register or data written in the address is read and supplied to the CPU 26.

The I2C control unit 30 is connected to a gate circuit 36, which is connected to an external tuner via an I2C bus. The I2C control unit 30 drives the I2C bus via the gate circuit 36, then supplies a clock SCL from the CPU 26 to the tuner 12, and sends the data SDA in a bidirectional manner. That is, data SDA is supplied via the I2C control unit 30 and the gate circuit 36 to the tuner 12 when an instruction from the CPU 26 instructs writing, and data SDA from the tuner 12 is supplied via the gate circuit 36 and the I2C control unit 30 to the CPU 26 when an instruction from the CPU instructs reading.

The digital demodulation IC 20 incorporates a digital demodulation circuit 40 for demodulating an IF signal from the tuner 12. The digital demodulation circuit 40 receives a system clock from the clock generator 24 via an oscillation circuit 42, so that the digital demodulation IC 20 operates using a system clock. It should be noted that the clock generator 24 is formed, for example, using a crystal oscillator.

The oscillation circuit 42 controls oscillation of the clock generator 24, based on set data on the register 34. The register 34 is connected also to the digital demodulation circuit 40, so that the operation of the digital demodulation circuit 40 is controlled based on the set data on the register 34.

It should be noted that, in the digital demodulation IC 20, the structural elements other than the digital demodulation circuit 40, namely, the I2C control unit 30 including the address decoder 32, the gate circuit 36, the register 34, and the oscillation circuit 42 are formed using I2C circuits which operate using a clock SCL and data SDA, but not a system clock. Thus, the register 34 is connected to the digital demodulation circuit 40 via an asynchronous interface.

In the above described structure, the CPU 26 supplies various set data to the digital demodulation IC 20. The set data includes at least data indicating whether to open or close the gate circuit 36, data indicating whether or not to cause the oscillation circuit 42 to operate the clock generator 24, and data indicating whether or not to cause the digital demodulation circuit 40 to operate, and the set data is written into the corresponding address in the register 34. Therefore, the CPU 26 can control operations of the gate circuit 36, the oscillation circuit 42, and the digital demodulation circuit 40 by instructing the I2C control unit 30, using data SDA, so as to write the above-described set data at a corresponding address in the register 34.

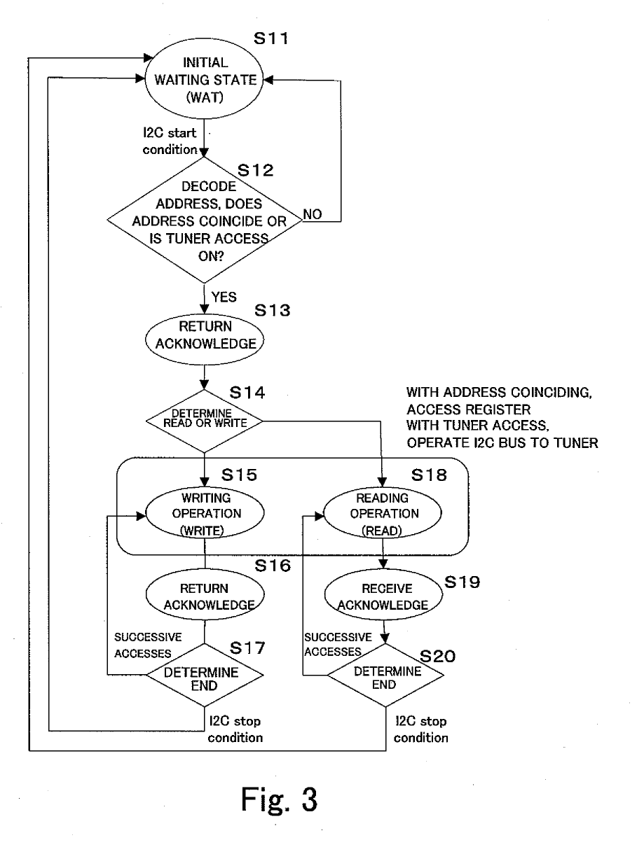

FIG. 3 shows sequential states of operation of the I2C control unit 30. Initially, the I2C control unit 30 is brought into an initial waiting state (S11), waiting for the I2C start condition to be satisfied. That is, the I2C control unit 30 monitors to ascertain whether or not the transmission start condition (I2C start condition) is satisfied, while referring to the clock SCL and the data SDA from the CPU 26. When the transmission start condition is satisfied, the address decoder 32 decodes the data SDA then supplied to restore an address contained therein, and determines whether or not the restored address coincides with its own slave address or the address of the tuner 12 (S12). When it is determined that these addresses do not coincide with each other, it is known that the data in the I2C bus is directed to some other device, and the initial waiting state at S11 is restored.

Meanwhile, when it is determined at S12 that the restored address coincides with the address of the I2C control unit 30 (same as the address of the digital demodulation IC 20 in this case) or the address of the tuner 12, the I2C control unit 30 sends acknowledgment to the CPU 26 (Acknowledge), utilizing a clock SCL and data SDA.

Then, whether the instruction instructs reading (READ) or writing (WRITE) is determined based on the content of the received data (S14). When an instruction instructing writing (WRITE) is received, data is written into the register 34 (S15). That is, the value of SDA is retrieved at a timing corresponding to falling of a clock SCL, an address inside the register 34 and write data are determined, and the data is written at the determined address.

When the write operation is completed, an acknowledgement is returned (S16), and whether or not the write operation is completed is determined (S17). When it is determined that the write operation is not yet completed, the process returns to S15 to repeat data writing until completion of the process is determined at S17.

Meanwhile, when it is determined at S14 that the instruction instructs reading (READ), data is read from the register 34 (S18) With the read operation completed, an acknowledgement is returned (S19), and whether or not the read operation is completed is determined (S20). When it is determined that the read operation is yet to be completed, the process returns to S18 to repeat the data reading until completion of the operation is determined at S20.

Here, the above-described description regarding S15 to S20 concerns an example in which the address restored in S12 coincides with the address of the I2C control unit 30, and data writing is carried out relative to the register 34. Meanwhile, when the address restored in S12 is the address of the tuner 12, the process at S15 to S20 is carried out relative to the register in the tuner 12.

Thereafter, when the CPU 26 writes or reads set data with respect to the tuner 12, the gate circuit 36 is opened, and the oscillation circuit 42 suspends operation of the clock generator 24. That is, initially, the CPU 26 writes set data for opening the gate circuit 36 and set data for stopping oscillation at a predetermined address in the register 34, or the slave address of the I2C control unit 30. Upon this writing of set data, the gate circuit 36 is opened and operation of the clock generator 24 is suspended. While the clock generator 24 operation is suspended, the I2C control unit 30 outputs the clock SCL and data SDA from the CPU 26 to the tuner 12. It should be noted that the notation “clock TUN₁₃ SCL” and “data TUN₁₃ SDA” given to the I2C bus connecting the gate circuit 36 and the tuner 12 in the drawing refer to a clock and data transmitted in the IC bus connected to the tuner 12, respectively, substantially identical to a clock SCL and data SDA, respectively.

Also, when the writing or reading of set data with respect to the tuner 12 is complete, the CPU 26 writes data for closing the gate circuit 36 in the register 34, and separates the I2C bus connected to the tuner 12 from the gate circuit 36. When a demodulation process by the digital demodulation circuit 40 is carried out, the CPU 26 writes data for driving the clock generator 24 in the register 34 to thereby ready the digital demodulation IC 20 for operation.

It should be noted that the I2C control unit 30 is initialized when the I2C stop condition is captured, and the value of SDA is captured upon the falling of a clock SCL. The register 34 is initialized upon system reset, with the value thereof updated upon the falling of a clock SCL, while the gate circuit 36 is initialized upon system reset, with the value thereof updated when the I2C start or stop condition is met.

That is, the I2C control circuit 30 incorporates a one-bit status signal indicating whether or not I2C communication is currently in a suspended state. For example, a status signal “1” indicates a suspended state, while a status signal “0” indicates a non-suspended state. When the CPU instructs suspension of the I2C communication while I2C communication is carried out, the I2C bus in the non-suspended state is changed to a suspended state, and the status signal is concurrently changed from “0” to “1”. When the CPU thereafter instructs resumption of I2C communication, the status signal is changed from “1” to “0”. That is, reference to the status signal can readily make it possible, even from the outside, to know the current state of the I2C bus.

As described above, in the digital demodulation IC 20, the address decoder 32 is initially caused to operate upon access by the CPU 26. Then, when a slave address of the I2C control unit 30 has been detected as a result of decoding, the value of the register 34 is read or updated. On the other hand, when no slave address has been detected, I2C data is exchanged between the I2C control unit 30 and the tuner 12 while the gate circuit 36 remains open. In neither case does the process return to the initial state at S11 in FIG. 3.

As described above, in the digital demodulation IC, the I2C control unit 30 can operate without using a system clock used in the digital demodulation circuit 40. Therefore, it is possible to control the clock generator 24, or an oscillation circuit of the system clock, and/or I2C communication with respect to the tuner by the game circuit 36k, without using a system clock. This makes it possible, when reception of an analog TV broadcast is desired, to receive broadcast analog TV signals without causing a system clock of the digital demodulation IC to operate, such that the reception is not affected by a noise from the system clock. Consequently, higher quality analog TV reception can be achieved.

What is claimed is:

1. A digital demodulation integrated circuit for use in a television reception system having a digital circuit and an analog circuit, comprising:
a data processing unit for operating using a clock supplied from an external processing unit via a serial bus, to decode data sent from the processing unit to restore an address contained in the data, and to retrieve a write address and write data contained in the data when the address designates the digital processing unit;
a register for storing the write data and the write address retrieved by the data processing unit in the write address;
a gate circuit for controlling whether or not data and a clock supplied from the processing unit are externally output, according to set data in the write data stored in the register; and
a digital demodulation circuit for operating using a system clock, different from the clock supplied from the processing unit, under control based on demodulation control data in the data stored in the register, to demodulate an encoded digital image signal input,
wherein
when the system clock is not supplied and the digital demodulation circuit is not operating, the data processing unit controls the gate circuit, and controls output of the clock and data from the processing unit.

2. The digital demodulation integrated circuit according to claim 1, wherein the serial bus is an I2C bus.

3. The digital demodulation integrated circuit according to claim 1, wherein
the system clock is generated using an incorporated oscillation circuit.

4. The digital demodulation integrated circuit according to claim 4, wherein
the oscillation circuit is controlled as to whether or not to generate a system clock according to the data stored in the register.
